(19) United States
(12) Patent Application Publication
(10) Pub. No.: US 2013/0260931 A1
(43) Pub. Date: Oct. 3, 2013

(54) HYDRAULIC AUTO-TENSIONER

(71) Applicant: NTN CORPORATION, Osaka (JP)

(72) Inventors: Seiji SATO, Shizuoka (JP); Hisashi HAYAKAWA, Shizuoka (JP)

(73) Assignee: NTN CORPORATION, Osaka (JP)

(21) Appl. No.: 13/832,123

(22) Filed: Mar. 15, 2013

(30) Foreign Application Priority Data
Mar. 29, 2012 (JP) 2012-076416

(51) Int. Cl. F16H 7/12

(52) U.S. Cl. CPC F16H 7/12
USPC 474/110

(57) ABSTRACT

A hydraulic auto-tensioner includes a cylinder containing hydraulic oil, a sleeve received in the cylinder, and a rod having its bottom end slidably inserted in the sleeve, defining a pressure chamber in the sleeve. A return spring is mounted between a spring seat provided at the top of the rod and the inner bottom surface of the cylinder to bias the cylinder and the rod such that the rod protrudes from the cylinder. A check valve is provided which closes when the pressure in the pressure chamber exceeds the pressure in the reservoir chamber. The check valve includes a valve seat slidably mounted in a valve fitting hole formed in the sleeve at its bottom end and pressed against an annular seating surface at the top of the valve fitting hole by an elastic member.

### CROSS REFERENCE TO RELATED APPLICATIONS

This application is based on and claims priority under 35 U.S.C. sctn. 119 with respect to Japanese Patent Application No. 2012-76416 filed on Mar. 29, 2012, the entire content of which is incorporated herein by reference.

### BACKGROUND OF THE INVENTION

This invention relates to a hydraulic auto-tensioner used to adjust the tension of an engine accessory driving belt.

A belt transmission assembly for transmitting the rotation of a crankshaft of an engine to various engine accessories such as an alternator, a water pump, and a compressor of an air-conditioner typically includes, as shown in FIG. 9, a pulley arm 43 provided on the slack side of the belt 41 so as to be pivotable about a pivot shaft 42, a tension pulley 44 supported on the end of the pulley arm 43 opposite to the pivot shaft 42, and a hydraulic auto-tensioner A for applying an adjusting force to the pulley arm 43 to bias the pulley arm 43 in the direction in which the tension pulley 44 is pressed against the belt 41, thereby keeping constant the tension of the belt 41.

A hydraulic auto-tensioner A used in such a belt transmission assembly is disclosed in JP Patent Publication 2000-504395A. This auto-tensioner includes a cylinder having a bottom and containing hydraulic oil, a sleeve extending from the inner surface of the bottom, and a rod having its lower portion slidably inserted in the sleeve, defining a pressure chamber in the sleeve. A return spring is mounted between a spring seat provided at the upper portion of the rod and the bottom surface of the cylinder to bias the rod and the cylinder such that the rod protrudes from the cylinder.

An elastic bellows has both ends thereof fitted to the outer periphery of the spring seat and the top outer edge of the cylinder, respectively, to define a sealed reservoir chamber between the cylinder and the sleeve. The reservoir chamber has its bottom portion in communication with the pressure chamber through a passage. A check valve is mounted in this passage. When a pushing force is applied to the hydraulic auto-tensioner A from the belt 41 through the tension pulley 44 and the pulley arm 43 that tends to push the rod into the cylinder, the check valve closes, so that hydraulic oil in the pressure chamber flows through a minute gap defined between the radially inner surface of the sleeve and the radially outer surface of the rod. The pushing force is dampened by hydraulic damping force generated in the pressure chamber due to viscous resistance of hydraulic oil that flows through the minute gap.

Thus, in this conventional hydraulic auto-tensioner, the damping force is substantially proportional to the pushing force, i.e. the force applied to the rod from the belt 41. This means that the hydraulic damping force increases as the pushing force increases.

Thus, this conventional auto-tensioner cannot prevent over-tensioning of the belt, which could reduce the durability of the belt.

In order to avoid this problem, the applicant of the present invention proposed in JP Patent Publication 2009-191863A a hydraulic auto-tensioner including a relief valve mounted in a passage formed in the rod through which the pressure chamber communicates with the reservoir chamber, whereby if the pressure in the pressure chamber exceeds a predetermined threshold, the relief valve is configured to open, thereby releasing pressure into the reservoir. With this arrangement, since the pressure in the pressure chamber never exceeds the above predetermined threshold, it is possible to prevent over-tensioning of the belt.

But since the hydraulic auto-tensioner disclosed in this patent publication requires two valves, i.e. the check valve and the relief valve, it is troublesome and time-consuming to assemble this auto-tensioner. Also, it is necessary to form the passage in the rod for receiving the relief valve, which pushes up the cost of this auto-tensioner.

### SUMMARY OF THE INVENTION

An object of the present invention is to provide a hydraulic auto-tensioner which includes fewer parts and thus is simpler in structure and lower in cost, and still can prevent over-tensioning of the belt.

In order to achieve this object, the present invention provides a hydraulic auto-tensioner comprising a cylinder in which hydraulic oil is stored, wherein the cylinder has a top opening and includes a bottom having an inner surface formed with a sleeve fitting hole, a sleeve having a bottom end portion fitted in the sleeve fitting hole and formed with a valve fitting hole at a bottom end portion of the sleeve, wherein the valve fitting hole has an annular top wall defining a seating surface, a rod having a lower portion slidably inserted in the sleeve, defining a pressure chamber in the sleeve by the lower portion of the rod, a spring seat provided at an upper portion of the rod, a return spring mounted between the spring seat and the inner surface of the bottom of the cylinder and biasing the cylinder and the rod in a direction in which the rod protrudes from the cylinder, wherein the top opening of the cylinder is closed, thereby defining a reservoir chamber between the cylinder and the sleeve, wherein a first communicating passage is defined between fitted surfaces of the sleeve fitting hole and the bottom end portion of the sleeve through which the pressure chamber communicates with the reservoir chamber, a check valve for closing the first communicating passage when a pressure in the pressure chamber exceeds a pressure in the reservoir chamber, the check valve comprising a valve seat slidably fitted in the valve fitting hole and formed with a valve hole, a valve body configured to selectively open and close an end of the valve hole facing the pressure chamber, and a retainer for restricting the degree of opening of the valve body; and an elastic member biasing the valve seat toward the seating surface, wherein a second communicating passage is defined between fitted surfaces of the valve fitting hole and the valve seat through which the interior of the valve fitting hole is configured to communicate with the pressure chamber if the valve seat is moved away from the seating surface against the biasing force of the elastic member.

In order to adjust the tension of the belt shown in FIG. 9 with the above-described hydraulic auto-tensioner, the bottom portion of the cylinder is pivotally coupled to the engine block and the spring seat provided at the upper portion of the rod is pivotally coupled to the pulley arm.

With the hydraulic auto-tensioner mounted in position in the above manner, when the tension of the belt increases and a pushing force is applied to the rod, since the pressure in the pressure chamber increases, the check vale closes, so that hydraulic oil in the pressure chamber leaks through the leak gap defined between fitted surfaces of the sleeve and the rod into the reservoir chamber. Due to the viscous resistance of the hydraulic oil leaking through the leak gap, a hydraulic damping force is generated in the pressure chamber which dampens the pushing force applied to the rod.

If the pressure in the pressure chamber further increases and exceeds the biasing force of the elastic member, the entire check valve descends against the biasing force of the elastic member, so that the valve seat is moved away from the seating surface, opening communication between the pressure chamber and the valve fitting hole through the second communicating passage. In this state, since the valve fitting hole communicates with the reservoir chamber through the first communicating passage, hydraulic oil in the pressure chamber is released into the reservoir chamber. Thus the hydraulic damping force generated in the pressure chamber never exceeds the biasing force of the elastic member.

This in turn prevents over-tensioning of the belt, and thus reduced durability of the belt.

The second communicating passage, through which the interior of the valve fitting hole is configured to communicate with the pressure chamber when the valve seat moves away from the seating surface against the force of the elastic member, may be an axial groove formed in at least one of the radially inner surface of the valve fitting hole and the radially outer surface of the valve seat, or may be a gap defined between the radially inner surface of the valve fitting hole and the radially outer surface of the valve seat.

The elastic member biasing the valve seat of the check valve toward the seating surface may be a compression spring, a wave washer or a spring washer.

According to this invention, as described above, if the pressure in the pressure chamber exceeds the biasing force of the elastic member biasing the valve seat of the check valve against the seating surface due to the pushing force applied to the rod from the belt, the entire check valve descends, so that the valve seat moves away from the seating surface. Hydraulic oil in the pressure chamber thus flows through the second communicating passage, valve fitting hole and first communicating passage into the reservoir chamber. This prevents the hydraulic damping force generated in the pressure chamber from exceeding the biasing force of the elastic member, and thus prevents over-tensioning of the belt.

Since the check valve and the elastic member serve as a relief valve, it is not necessary to mount a separate relief valve. It is also not necessary to form a communicating passage in the rod through which the pressure chamber communicates with the reservoir chamber. Thus, the hydraulic auto-tensioner according this invention is made up of fewer component parts, easier to assemble and less costly than conventional hydraulic auto-tensioners.

The second communicating passage, through which the pressure chamber communicates with the valve fitting hole when the valve seat is moved away from the seating surface, are formed between fitted surfaces of the valve seat and the valve fitting hole and short in axial length. Thus, pressure in the pressure chamber can be released instantly as soon as the valve seat moves away from the seating surface. Thus, it is possible to instantly eliminate any over-tensioned state of the belt.

### BRIEF DESCRIPTION OF THE DRAWINGS

FIG. 1 is a vertical sectional view of a hydraulic auto-tensioner embodying the present invention;

FIG. 2 is an enlarged sectional view of a portion of the auto-tensioner of FIG. 1 where a check valve is mounted;

FIG. 3 is a view similar to FIG. 2 and shows how the check valve of FIG. 2 functions as a relief valve;

FIG. 4 is a sectional view taken along line IV-IV of FIG. 2;

FIG. 5 is a sectional view showing a different sleeve;

FIG. 6 is a sectional view showing a different second communicating passage;

FIG. 7A is a vertical sectional view showing a still different second communicating passage;

FIG. 7B is a sectional view taken along line VII-VII of FIG. 7A;

FIG. 8A is a perspective view of a different elastic member;

FIG. 8B is a perspective view of a still different elastic member; and

FIG. 9 is a front view of a tension adjusting assembly for an engine accessory driving belt.

### DETAILED DESCRIPTION OF THE PREFERRED EMBODIMENTS

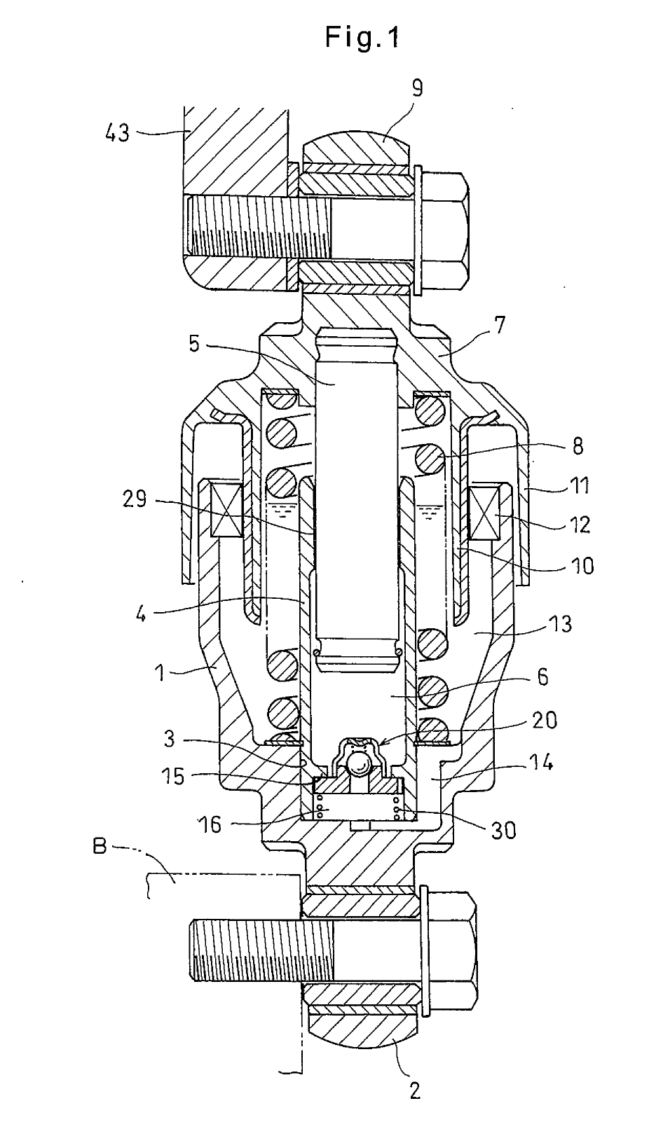

Now referring to the drawings, the auto-tensioner embodying the present invention includes, as shown in FIG. 1, a cylinder 1 having a closed bottom end formed with a coupling piece 2 rotatably coupled to an engine block.

A sleeve fitting hole 3 having a smaller diameter than the inner diameter of the cylinder 1 is formed in the inner bottom surface of the cylinder 1. A sleeve 4 has its bottom end portion press-fitted in the sleeve fitting hole 3. A rod 5 has its lower portion slidably inserted in the sleeve 4, defining a pressure chamber 6 in the sleeve 4.

A spring seat 7 is fixed to the top end portion of the rod 5, which protrudes from the cylinder 1. A return spring 8 is mounted between the spring seat 7 and the inner bottom surface of the cylinder 1, biasing the cylinder 1 and the rod 5 in the direction in which the rod 5 protrudes from the cylinder 1.

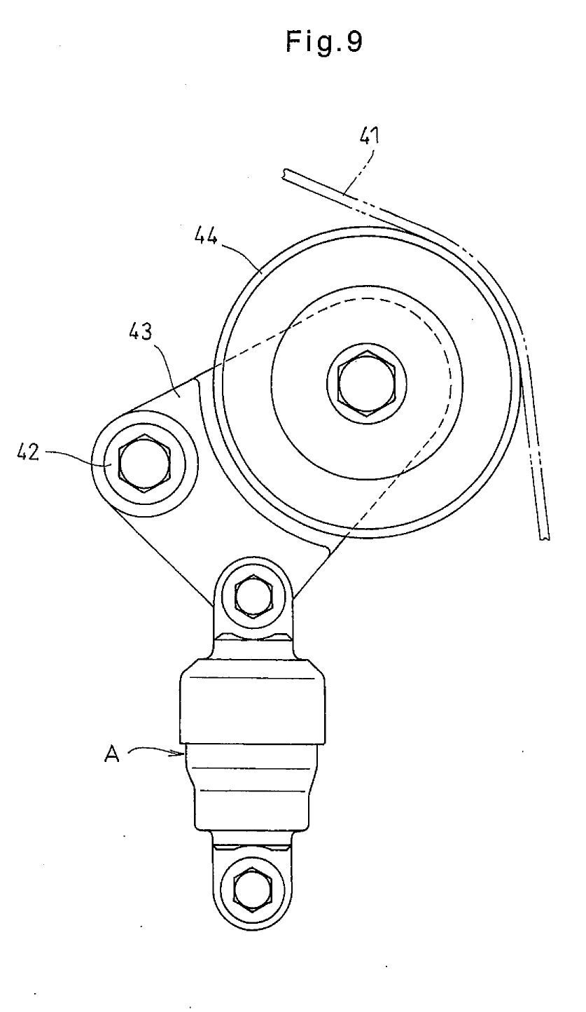

The spring seat 7 has a coupling piece 9 at its top end which is configured to be coupled to the pulley arm 43 shown in FIG. 9. The spring seat 7 further includes an inner tubular portion 10 covering the upper portion of the return spring 8, and an outer tubular portion 11 coaxial with the inner tubular portion 10 and covering the outer periphery of the upper portion of the cylinder 1.

An elastic seal 12 such as an oil seal is fitted in the cylinder 1 at its top opening with its inner periphery in elastic contact with the outer periphery of the inner tubular portion 10, closing the top opening of the cylinder 1, thus preventing hydraulic oil in the cylinder 1 from leaking out of the cylinder 1.

The elastic seal 12 defines a sealed reservoir chamber 13 between the cylinder 1 and the sleeve 4. The reservoir chamber 13 communicates with the pressure chamber 6 through a first communicating passage 14 defined between the fitted surfaces of the sleeve fitting hole 3 and the sleeve 4.

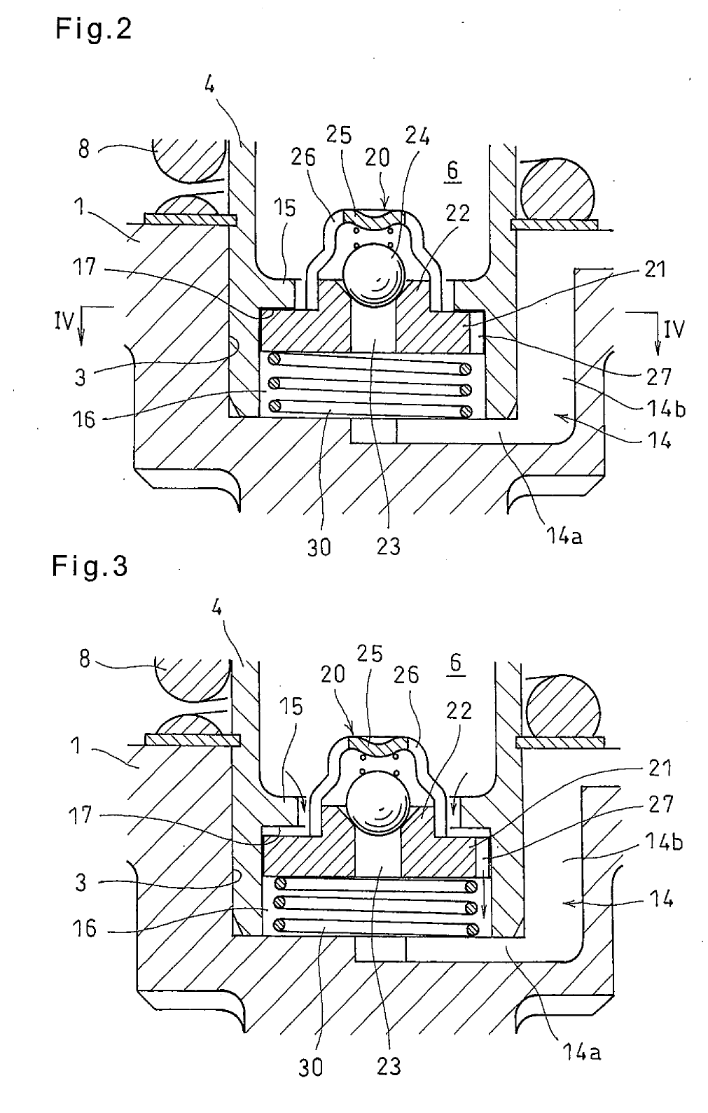

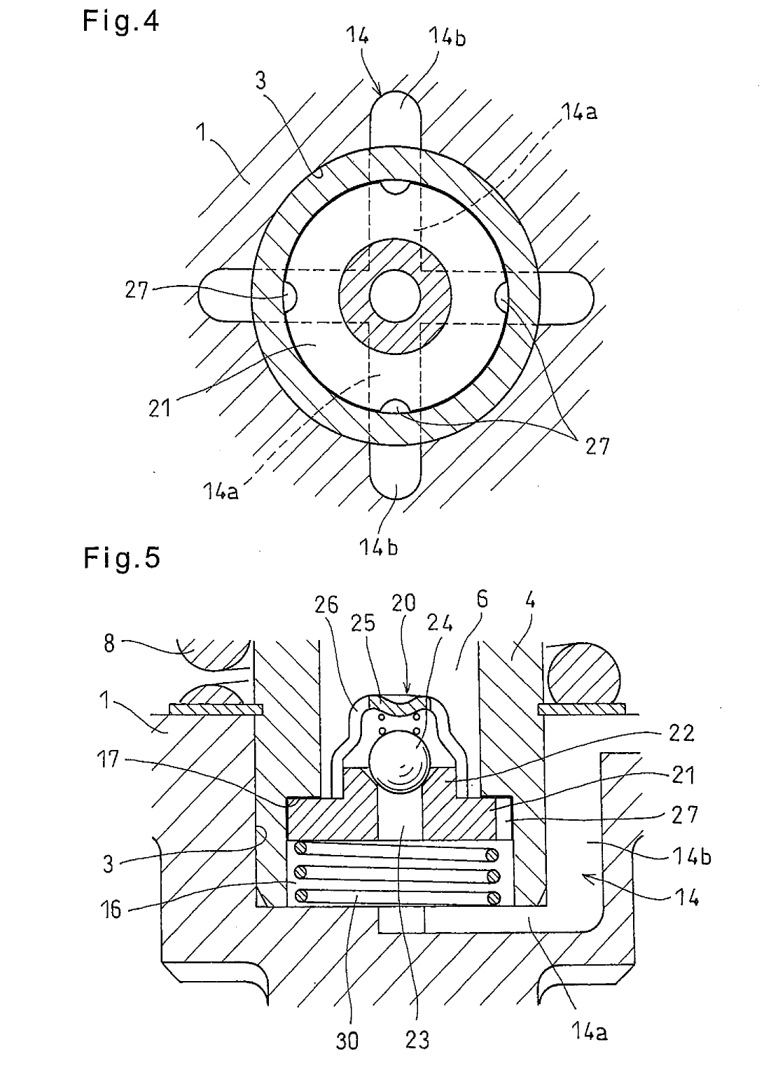

As shown in FIGS. 2 and 4, the first communicating passage 14 is made up of radial grooves 14a formed in the bottom surface of the sleeve fitting hole 3 and forming a cross, and four axial grooves 14b formed in the radially inner surface of the sleeve fitting hole 3 and communicating with the outer ends of the respective radial grooves 14a.

As shown in FIG. 2, the sleeve 4 has at its bottom end portion an annular protrusion 15 protruding from the radially inner surface of the sleeve 4. The sleeve 4 thus defines therein a valve fitting hole 16 of which the top wall is the annular protrusion 15. The annular protrusion 15 as the top wall of the valve fitting hole 16 has a flat seating surface 17.

Instead of defining the valve fitting hole 16 by the annular protrusion 15 as shown in FIG. 2, a large-diameter hole 16 may be formed in the bottom end portion of the sleeve 4, which has a cylindrical radially inner surface, as the valve fitting hole, as shown in FIG. 5.

A check valve 20 and an elastic member 30 are mounted in the valve fitting hole 16. The check valve 20 includes a valve seat 21 having a columnar protrusion 22 formed on the center of the top surface of the valve seat 21. A valve hole 23 extends from the top surface of the protrusion 22 to the bottom surface of the valve seat 21. The check valve 20 further includes a spherical valve body 24 for selectively opening and closing the valve hole 23 at its end facing the pressure chamber 6, and a retainer 25 having a bottom opening press-fitted on the protrusion 22 for restricting the degree of opening of the valve body 24. The retainer 25 has oil passage windows 26.

The check valve 20 is mounted such that the valve seat 21 can slide in the valve fitting hole 16. The elastic member 30, mounted under the check valve 20, biases the valve seat 21 upwardly, pressing the outer peripheral edge portion of the top surface of the valve seat 21 against the seating surface 17.

The check valve 20 is configured such that when the pressure in the pressure chamber 6 exceeds the pressure in the reservoir chamber 13, the valve body 24 closes the valve hole 23. Further, the check valve 20 is configured such that when the pressure in the pressure chamber 6 exceeds the spring force of the elastic member 30, the entire check valve 20 descends such that the valve seat 21 moves away from the seating surface 17.

As shown in FIGS. 2 and 4, a plurality of circumferentially spaced apart second communicating passages 27 are formed in the outer periphery of the valve seat 21 such that when the valve seat 21 is apart from the seating surface 17 (see FIG. 3), the pressure chamber 6 communicates with the valve fitting hole 16 through the second communicating passages 27. The second communicating passages 27 shown are axial grooves.

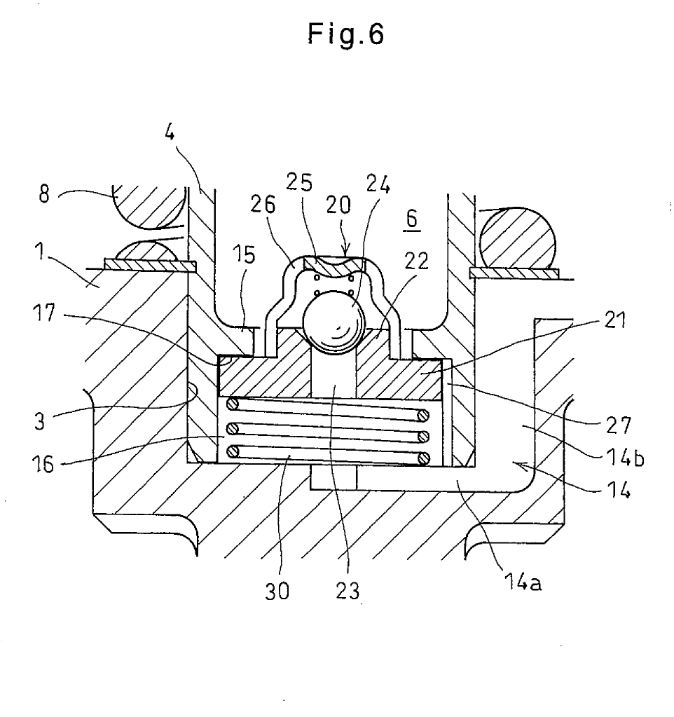

The second communicating passages 27 shown in FIGS. 2 and 4 are axial grooves formed in the outer periphery of the valve seat 21. But instead, as shown in FIG. 6, axial grooves may be formed in the radially inner surface of the valve fitting hole 16 as the second communicating passages 27.

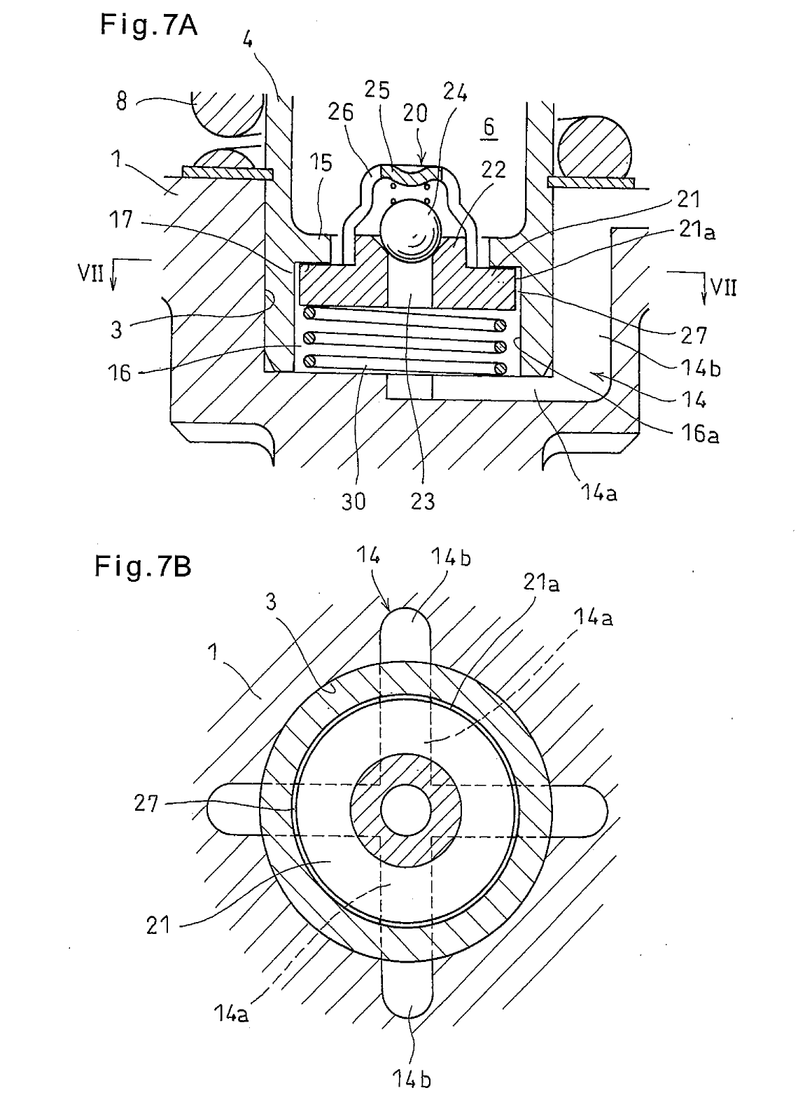

In the arrangement of FIGS. 7A and 7B, the valve seat 21 has a cylindrical radially outer surface 21a, and an annular gap 27 is defined between the cylindrical radially outer surface 21a and the radially inner surface 16a (which is also cylindrical) of the valve fitting hole 16. The annular gap 27 serves as a second communicating passage corresponding to the second communicating passages 27 of e.g. FIG. 2.

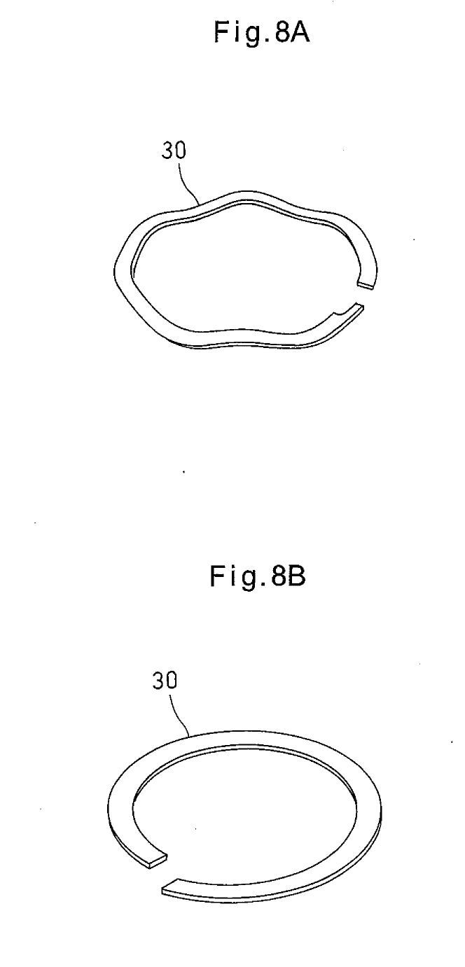

In FIG. 2, the elastic member 30 is a compression coil spring. But the elastic member 30 is not limited to a compression spring, and may be e.g. a wave washer as shown in FIG. 8A or a spring washer as shown in FIG. 8B.

The hydraulic auto-tensioner of the embodiment can be used to adjust the tension of the engine accessory driving belt 41 shown in FIG. 9. For this purpose, the coupling piece 2 at the closed end of the cylinder 1 is coupled to the engine block B shown in FIG. 1, and the coupling piece 9 of the sprig washer 7 is coupled to the pulley arm 43 such that the adjusting force from the auto-tensioner is applied to the pulley arm 43.

The tension of the belt 41 changes due to fluctuations in load applied to engine accessories. With the auto-tensioner mounted in position in the above manner, when the tension of the belt 41 decreases, the cylinder 1 and the rod 5 are moved relative to each other in the direction in which the rod 5 protrudes from the cylinder 1, under the biasing force of the return spring 8, thus eliminating slackness of the belt 41.

When the cylinder 1 and the rod 5 move relative to each other in the direction in which the rod 5 protrudes from the cylinder 1, the pressure in the pressure chamber 6 drops below the pressure in the reservoir chamber 13. The valve body 24 of the check valve 20 is thus moved to open the valve hole 23, allowing hydraulic oil in the reservoir chamber 13 to smoothly flow through the first communicating passage 14 and the valve hole 23 into the pressure chamber 6. Thus, the cylinder 1 and the rod 5 can smoothly move relative to each other in the direction in which the rod 5 protrudes from the cylinder 1, thus quickly eliminating slackness of the belt 41.

When the tension of the belt 41 increases, a pushing force is applied to the hydraulic auto-tensioner from the belt 41 that tends to move the cylinder 1 and the rod 5 in the direction in which the rod 5 is pushed into the cylinder 1. This increases the pressure in the pressure chamber 6 higher than the pressure in the reservoir chamber 13, thus moving the valve body 24 of the check valve 20 to close the valve hole 23 as shown in FIG. 2.

In this state, hydraulic oil in the pressure chamber 6 flows through a minute leak gap 29 defined between the radially inner surface of the sleeve 4 and the radially outer surface of the rod 5 and into the reservoir chamber 13. Due to viscous resistance of hydraulic oil flowing through the leak gap 29, hydraulic damping force is generated in the pressure chamber 6 which dampens the pushing force applied to the hydraulic auto-tensioner, allowing the cylinder 1 and the rod 5 to slowly move relative to each other in the direction in which the rod 5 is pushed into the cylinder, until the pushing force balances with the biasing force of the return spring 8.

If the tension of the belt 41 increases to such a level that the pressure in the pressure chamber 6 exceeds the biasing force of the elastic member 30, as shown in FIG. 3, the entire check valve 20 descends against the biasing force of the elastic member 30, so that the valve seat 21 moves away from the seating surface 17. The pressure chamber 6 thus communicates with the valve fitting hole 16 through the second communicating passages 27.

In this state, since the valve fitting hole 16 communicates with the reservoir chamber 13, shown in FIG. 1, through the first communicating passage 14, hydraulic oil in the pressure chamber 6 flows through the second communicating passages 27, the valve fitting hole 16 and the first communicating passage 14 into the reservoir chamber 13. This prevents the hydraulic damping force generated in the pressure chamber 6 from rising above the biasing force of the elastic member 30, thus preventing over-tensioning of the belt 41.

In the embodiment, as described above, if the pressure in the pressure chamber 6 exceeds the biasing force of the elastic member 30, the check valve 20 descends such that the valve seat 21 is moved away from the seating surface 17, opening the pressure chamber. With this arrangement, since the check valve 20 and the elastic member 30 serve as a relief valve, it is not necessary to mount a separate relief valve. It is also not necessary to form a communicating passage in the rod 5 through which the pressure chamber 6 communicates with the reservoir chamber 13. Thus, the hydraulic auto-tensioner according this invention is made up of fewer component parts, easier to assemble and less costly than conventional hydraulic auto-tensioners.

The second communicating passage or passages 27, through which the pressure chamber 6 communicates with the valve fitting hole 16 when the valve seat 21 is moved away from the seating surface 17, are formed between fitted surfaces of the valve seat 21 and the valve fitting hole 16 and short in axial length. Thus, pressure in the pressure chamber 6 can be released instantly as soon as the valve seat 21 moves away from the seating surface 17. Thus, it is possible to instantly eliminate any over-tensioned state of the belt 41.

What is claimed is:

1. A hydraulic auto-tensioner comprising:
a cylinder in which hydraulic oil is stored, wherein the cylinder has a top opening and includes a bottom having an inner surface formed with a sleeve fitting hole;
a sleeve having a bottom end portion fitted in the sleeve fitting hole and formed with a valve fitting hole at a bottom end portion of the sleeve, wherein the valve fitting hole has an annular top wall defining a seating surface;
a rod having a lower portion slidably inserted in the sleeve, defining a pressure chamber in the sleeve by the lower portion of the rod;
a spring seat provided at an upper portion of the rod;
a return spring mounted between the spring seat and the inner surface of the bottom of the cylinder and biasing the cylinder and the rod in a direction in which the rod protrudes from the cylinder, wherein the top opening of the cylinder is closed, thereby defining a reservoir chamber between the cylinder and the sleeve, wherein a first communicating passage is defined between fitted surfaces of the sleeve fitting hole and the bottom end portion of the sleeve through which the pressure chamber communicates with the reservoir chamber;
a check valve for closing the first communicating passage when a pressure in the pressure chamber exceeds a pressure in the reservoir chamber, the check valve comprising a valve seat slidably fitted in the valve fitting hole and formed with a valve hole, a valve body configured to selectively open and close an end of the valve hole facing the pressure chamber, and a retainer for restricting the degree of opening of the valve body; and
an elastic member biasing the valve seat toward the seating surface, wherein a second communicating passage is defined between fitted surfaces of the valve fitting hole and the valve seat through which the interior of the valve fitting hole is configured to communicate with the pressure chamber if the valve seat is moved away from the seating surface against the biasing force of the elastic member.

2. The hydraulic auto-tensioner of claim 1, wherein the second communicating passage comprises an axial groove formed in at least one of a radially inner surface of the valve fitting hole and a radially outer surface of the valve seat.

3. The hydraulic auto-tensioner of claim 1, wherein the valve fitting hole has a cylindrical radially inner surface and the valve seat has a cylindrical radially outer surface, and wherein the second communicating passage comprises a gap defined between the cylindrical radially inner surface and the cylindrical radially outer surface.

4. The hydraulic auto-tensioner of claim 1, wherein the elastic member comprises one of a compression spring, a wave washer and a spring washer.

5. The hydraulic auto-tensioner of claim 2, wherein the elastic member comprises one of a compression spring, a wave washer and a spring washer.

6. The hydraulic auto-tensioner of claim 3, wherein the elastic member comprises one of a compression spring, a wave washer and a spring washer.
